(19) United States
(12) Patent Application Publication
(10) Pub. No.: US 2007/0071234 A1
(43) Pub. Date: Mar. 29, 2007

(54) Methods for the storage and reading of a content, of the type implementing a content protection protocol, corresponding source, storage and sink devices

(75) Inventors: Pascal Lagrange, Rennes (FR); Jean-Paul Accarie, Vern Sur Seiche (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 11/303,027

(22) Filed: Dec. 16, 2005

(30) Foreign Application Priority Data
Jan. 6, 2005 (FR) 05 00123

(51) Int. Cl. H04L 9/28

(52) U.S. Cl. 380/28

(57) ABSTRACT

A method for the storage of a content from a source device to a storage device, the devices implementing a content protection protocol comprising a phase of exchanging a first encryption key (Kc) associated with a first key computation parameter (Nc). A storage method of this kind comprises the following steps; the obtaining (802) of a first processing function (m1) that is a function of a predetermined piece of information for access to the content to be stored (CPK); the obtaining (805) of a second key computation parameter (Ncpk; Ncm) in taking account of said first processing function; the computation (806) of a second encryption key (Kcpk), in taking account of said second key computation parameter (Ncpk; Ncm); the encryption (810) of the content to be stored with said second key (Kcpk), thus obtaining a first encrypted content (Msa0), and then the encryption (811) of the first encrypted content (Msa0) with the first key (Kc), thus obtaining a second encryption content (Msa); the sending (812) of the second encrypted key (Msa) to the storage device; and the storing (808) of at least one piece of computation data (Ncm; Nc) necessary for the computation of said second parameter (Ncpk; Ncm).

### 1. FIELD OF THE INVENTION

The field of the invention is that of data communications networks. More particularly the invention relates to the restriction of access to contents, especially but not exclusively isochronous data, stored in storage units in such a network.

There are known communications networks today to which there are connected different apparatuses generating and/or receiving isochronous data contents, as well as units (such as external hard disk drives) to store these contents.

The invention can be applied especially but not exclusively in the case of a multimedia network where the isochronous data stream conveys audio-video (AV) type data.

### 2. PRIOR ART

The modern equipment that a family may install often has the task of transmitting different types of data such as video, sound, photographs, text files and so on. The transmission of this data is governed by requirements that can vary according to the type of data considered. In particular, this data must be conveyed by means of cables or adapted links. Thus, each data format has a corresponding adapted means of transportation and a type of connector by which the devices are connected to each other. For example, devices processing digital data may work according to the IEEE-1394 standard.

An embodiment of the invention can be applied especially but not exclusively to an audio-video network, for example a home network comprising a backbone network, itself comprising nodes. The nodes have items of equipment or devices connected to them, directly through analog links or indirectly, for example, through serial digital buses compliant with the IEEE-1394 standard. It may be recalled that this standard is described in the following reference documents: “IEEE Std 1394-1995, Standard for High Performance Serial Bus” and “IEEE Std 1394a-2000, Standard for High Performance Serial Bus (Supplement)”.

FIG. 1A illustrates an example of an audio-video home network 1000 of this kind. This home network 1000 comprises a backbone network 1001, itself comprising nodes 003, 004, 005 interconnected through a central switching unit 015.

As can be seen in FIG. 1B, the central switching unit 015 has several switching devices 150a, 150b, 150c and 150d. For the sake of simplicity, FIG. 1B shows a switching unit 015 such as this comprising only four switching devices, 150a, 150b, 150c and 150d.

The switching device 150a is connected by means of a cable 153a to the switching device 150d. It is also connected by means of another cable 153d to the switching device 150c which is itself connected by another link 153e to the switching device 150d.

The switching device 150c is connected to the switching device 150b by means of a link 153c and finally the switching device 150b is connected to the switching device 150a by means of a communications link 153b.

It must be noted that the switching devices 150a, 150b, 150c and 150d are, in this example, inserted in the partition walls of a dwelling. The device 150a is placed, for example, in the partition wall 152a of a room such as a living room, the device 150b in the partition wall 152b of another room such as the kitchen, the device 150c in the partition wall 120c of a room such as a study, and the device 150d in the partition wall 152d of a bedroom.

However, the switching devices 150a, 150b, 150c and 150d may be independent of the partition walls and may thus be movable.

The switching devices 150a, 150b and 150c (FIG. 1B) are connected to the nodes 003, 004 and 005 (referenced NA, NB and NC respectively in FIG. 1A) of the backbone network 1001 by means of a single medium, in this case cables 151a, 151b and 151c.

Furthermore, as can be seen in FIG. 1A, the node 003 is also connected to terminal devices:
a television set 014, a DVD player 013 and a VHS videocassette player 012 through analog links;
an audio-video hard disk drive 006, a VHS digital videocassette player 007 and an IEEE-1394 compliant digital DVD player 008 by means of an IEEE-1394 digital serial bus 001.

The node 004 is connected through an IEEE-1394 002 digital serial bus to a digital television set 009, a digital VHS videocassette recorder 010 and an IEEE-1394 tuner 011.

In a network, such as the home network 1000 of FIG. 1A, the contents stored in storage units connected to the network by IEEE 1394 buses need to be protected when these contents are transmitted from the storage unit to the network. A first known technique used to guarantee copy protection for isochronous streams (such as audio-video contents) during their transmission in a home network lies in the implementation of the DTCP (“Digital Transfer Content Protection”) protocol. The characteristics and recommendations of this protocol are described in detail in the following reference document: “Digital Transmission Content Protection Specification, Volume 1 and 2, Draft 1.29”.

FIG. 2 illustrates the implementation of the DTCP protocol during the transmission of a content between a source device, referenced A, and a receiver or sink device, referenced B.

The classic DTCP protocol comprises a phase of a mutual authentication 200 between the sink device B and the source device A, followed by a phase for the exchange of keys between these two devices A and B.

The authentication phase 200 comprises the following steps:
in a first step 201, the sink or receiver device B issues an authentication request, comprising information for the authentication of this sink device B, which it sends to the source device A;
in a second step 202, the source device A verifies the information for the authentication of the sink device B;
in a third step 203, the source device A sends the sink device B a message of response to the above-mentioned authentication request, comprising information for the authentication of the source device A;
in a fourth step, the sink device B verifies the information for the authentication of the source device A;
in a fifth step 205, the source device A sends the sink device B a first signed message comprising information specific to the DTCP protocol;
in a sixth step 206, the sink device B checks the first signed message from the source device A and computes a first authentication key;
in a seventh step 207, the sink device B in turn sends the source device A a second signed message comprising information specific to the DTCP protocol;
in an eighth step 208, the source device A checks the second signed message from the sink device B and computes a second authentication key.

The key exchange phase 210 comprises the following steps:
in a ninth step 211, the source device A generates a piece of random information, for example a random number Nc1, and computes an encryption key Kc1 which is a function especially of this random number Nc1 and which verifies that Kc1=J[Kx, EMI, Nc1], where J is a determined function, EMI and Kx are the classic parameters of the PTCP protocol;
in a tenth step 212, the random number Nc is sent by the source device A to the sink device B;
in an eleventh step 213, the sink device B computes the encryption key Kc1 by means of the random number Nc1;
in a twelfth step 214, the source device A, in applying a determined function f_{Kc1}, encrypts the content by means of the encryption key Kc1 so as to obtain an encrypted content referenced Msa1;
in a thirteenth step 215, the source device A sends the encrypted content Msa1 to the sink device B;
in a fourteenth step 216, the sink device B decrypts the encrypted content Msa1 by means of the encryption key Kc1, in applying a function f_{Kc1}⁻ (which is the reciprocal function of the function f_{Kc1).}

A second prior art technique designed to guarantee copy protection for isochronous contents during transmission in a network is presented in the international patent application No. WO0239661 (belonging to the firm COAXMEDIA Inc.).

This second technique proposes to implement a preliminary step for the first encryption of an encryption key followed by a step for a second encryption of a content with the encrypted key before transmitting the content in a communications network.

A third prior art technique is designed to ensure protection against the copying of isochronous contents during their transmission in a network is described in the European patent application No. EP1122910 (belonging to the firm MITSUBISHI Corp.).

This third technique comprises a method for the protection of contents based on two consecutive encryption steps: the first step uses a static encryption key and the second step uses an encryption key that evolves dynamically in time (the order of the two encryption keys may be inverted), and vice versa.

Thus, these latter two techniques based on double encryption are used for providing security to the transfer of contents on a medium. However, a first drawback is that they cannot be used to protect contents outside the context of their transfer.

Furthermore, the encryption and decryption are not done from a same device. Indeed, the device on which the data are stored (for example a storage unit) possesses means to decrypt the data. A second drawback of these techniques there is that it is necessary to implement especially decryption means in the storage devices which become active storage devices. Thus, it is not possible to use classic storage devices to implement these prior art techniques.

Furthermore, in a network implementing, for example, the DTCP protocol, when a device that is external to this network but itself also implements the DTCP protocol gets connected directly to a storage device of this network, it may, according to a classic mode of DTCP implementation, access the data of the storage device.

Thus, a third drawback of this type of classic technique is that individuals can have unrestricted access to the contents of the storage device.

### 3. Goals of the Invention

The invention is aimed especially at overcoming these different drawbacks of the prior art.

More specifically, one of the goals of the present invention, in at least one embodiment, is to provide an improved technique to restrict access by a sink device to a content stored in a storage device, when both these devices implement a content protection protocol (for example the DTCP protocol).

It is also a goal of the invention, in at least one of its embodiments, to implement a technique of this kind that makes it possible, if a first network is used during storage, to ensure content access restriction when the storage device is used, during content reading or playback, in a second network distinct from the first network, where this second network does not implement the same access restriction and control technique of one embodiment of the invention as the technique implemented by the first network.

Another goal of the invention, in at least one of its embodiments, is to prevent access to a content on a detachable support when this detachable support is accessed by a device external to the network.

Yet another goal of the invention, in at least one of its embodiments, is to implement such a technique that enables the use of classic storage devices and therefore removes the need to implement any non-specific means in the storage devices which remain passive.

It is yet another goal of the invention, in at least one embodiment, to provide such a technique that is reliable, easy to implement and costs little.

### 4. Essential Characteristics of the Invention

These different goals as well as others that shall appear here below are achieved according to the invention, in at least one of its embodiments, by means of a method for the storage of a content from a source device to a storage device, the devices implementing a content protection protocol comprising a phase of exchanging a first encryption key associated with a first key computation parameter.

According to the invention, in at least one of its embodiments, a storage method of this kind comprises the following steps:
the obtaining of a first processing function that is a function of a predetermined piece of information for access to the content to be stored;
the obtaining of a second key computation parameter in taking account of said first processing function;
the computation of a second encryption key, in taking account of said second key computation parameter;
the encryption of the contents to be stored with said second key, thus obtaining a first encrypted content, and then the encryption of the first encrypted content with the first key, thus obtaining a second encrypted content;
the sending of the second encrypted content to the storage device; and
the storing of at least one piece of computation data necessary for the computation of said second parameter.

This type of storage method therefore offers a twofold level of security for access to the content and restricted access to devices of the communications network implementing the invention, in at least one of its embodiments.

Indeed, the storage device and the source device implement the protection protocol that enables the decryption, for a first time, of the content of the storage device by means of the key Kc exchanged according to the protocol. However, the decrypted content is accessible only if the device is capable of computing the second encryption key from said at least one piece of computation data. A device that does not implement the invention cannot compute this key.

Thus, the invention, in at least one of its embodiments, proposes a method that enables access to a content stored in a storage device only when the reading or playback device comes from a network that possesses nodes implementing the invention in at least one of its embodiments.

Preferably, the second key computation parameter is computed with a first function in taking account of the first processing function obtained and the first key computation parameter.

Advantageously, the storage of said at least one piece of computation data is done by the sending of this said at least one piece of data to the storage device.

According to an advantageous characteristic of the invention, in at least one of its embodiments, said at least one piece of computation data is computed with a second function in taking account of the first processing function obtained and of the first key computation parameter.

Preferably, another piece of computation data is a parameter for re-updating the second key computation parameter.

According to a first advantageous embodiment of the invention, the re-updating parameter is a time period of a predetermined duration.

According to a second advantageous embodiment of the invention, with the content comprising packets, the re-updating parameter is a predetermined number of packets encrypted with the second key.

Advantageously, the storage method according to the invention, in at least one of its embodiments, furthermore comprises the following steps:
the implementation of a mechanism making it possible to increment the second key computation parameter as a function of the re-updating parameter;
the re-computation of the second encryption key after each incrementation of the second key computation parameter.

Thus, the re-updating of the second encryption key offers an additional guarantee on access control to the content.

According to an advantageous characteristic of the invention, in at least one of its embodiments, the re-updating parameter for the second key computation parameter is encrypted by means of a third function taking account of the first processing function so as to form a piece of computation data.

Preferably, the storage of said at least one piece of computation data is done locally.

For example, the storage is done on the source device.

According to an advantageous mode of implementation of the invention, in at least one of its embodiments, said at least one piece of computation data is the first key computation parameter.

Advantageously, said predetermined piece of information for access to the content to be stored is a password associated with said content and/or said storage device.

Preferably, said content protection protocol is the DTCP protocol.

However, the invention, in at least one of its embodiments, can also be adapted to any other content protection protocol.

The invention, in at least one of its embodiments, also relates to a method for the reading of a content coming from a storage device to a sink device, the content having been stored according to the storage method as described here above, said devices implementing a content protection protocol comprising a phase of exchange of a third encryption key associated with a third key computation parameter.

According to the invention, in at least one of its embodiments, a read method of this kind comprises the following steps:
the reception of a third encrypted content from the storage device, obtained by encryption with the third encryption key of the first encrypted content;
the obtaining of at least one piece of computation data;
the obtaining of a second processing function which is a function of a piece of information authorizing access to the content to be read, said second processing function being identical to said first processing function if the access authorizing information corresponds to a predetermined piece of information for access to the stored content;
the obtaining, in taking account of said second processing function and of said computation data, of a second key computation parameter;
the computation of the second encryption key, in taking account of said second key computation parameter;
the decryption of the third content encrypted with the third key, thus obtaining said first encrypted content, and then the decryption, with the second key, of said first encrypted content, thus obtaining a non-encrypted content.

Thus, if a fraudulent user tries to play back a restricted-access content, stored in a storage device, using a sink device that is incapable of implementing the content protection protocol, modified according to the invention, in at least one of its embodiments, (in the case for example of a node of another network that does not implement the present invention) and/or if this fraudulent user does not know the right password, he or she will not have access to the content.

Preferably, the second key computation parameter is computed, with a first function, in taking account of the second processing function obtained and a first key computation parameter obtained by the computation according to a second function taking account of said at least one computation data element and the second processing function.

Advantageously, the obtaining of said at least one piece of computation data is done by the reading of this piece of data stored in the storage device.

According to an advantageous characteristic of the invention, in at least one of its embodiments, one of said at least one piece of computation data is a parameter for re-updating the second key computation parameter.

According to a first advantageous embodiment of the invention, the re-updating parameter is a time period of a predetermined duration.

According to a first advantageous embodiment of the invention, with the content comprising packets, the re-updating parameter is a predetermined number of packets encrypted with the second key.

Preferably, the read procedure furthermore comprises the following steps:
the implementation of a mechanism enabling the incrementing of the second key computation parameter as a function of the re-updating parameter;
the re-computation of the second encryption key after each incrementation of the second key computation parameter.

Preferably, the obtaining of said at least one computation data is done by the retrieval of said at least one computation data on the source device that has incremented the storage method as described here above.

According to a preferred characteristic of the invention, in at least one of its embodiments, said access authorization information for the content to be read is a user password.

According to an advantageous mode of implementation of the invention, said predetermined information for access to the stored content is a password associated with said content and/or said storage device.

Preferably, said content protocol is the DTCP protocol.

The invention, in at least one of its embodiments, also relates to a computer program product comprising program code instructions for the execution of the steps of the storage method as described here above, when said program is executed on a computer.

The invention, in at least one of its embodiments, also relates to a computer program product comprising program code instructions for the execution of the steps of the content reading method as described here above, when said program is executed on a computer.

The invention, in at least one of its embodiments, also relates to a storage means which may be totally or partially detachable, readable by a computer, storing a set of instructions that can be executed by said computer to implement the storage method as described here above.

The invention, in at least one of its embodiments, also relates to a storage means which may be totally or partially detachable, readable by a computer, storing a set of instructions that can be executed by said computer to implement the content reading method as described here above.

The invention, in at least one of its embodiments, also relates to a source device implementing means for storage of a content on a storage device, the devices implementing a content protection protocol comprising a phase for the exchange of a first encryption key associated with a first key computation parameter, the storage device comprising:
means for obtaining a first processing function which is a function of a predetermined piece of information pertaining to access to the content to be stored;
means for obtaining a second key computation parameter in taking account of said first processing function;
means for computing a second encryption key in taking account of said second key computation parameter;
first means of encryption of the content to be stored with said second key, making it thus possible to obtain a first encrypted content, and then second means for the encryption of the first encrypted content with the first key, thus making it possible to obtain a second encrypted content;
means for sending the second encrypted content to the storage device;
means for the storage of at least one computation data element necessary for the content of said second parameter.

Preferably, the source device according to the invention, in at least one of its embodiments, comprises means for the computation of the second key computation parameter implementing a first function, in taking account of the first processing function obtained and the first key computation parameter.

Advantageously, the means for storing said at least one piece of computation data implement means for sending this said at least one piece of data to the storage device.

Preferably, the source device according to the invention, in at least one of its embodiments, comprises means to compute said at least one piece of computation data implementing a second function taking account of the first processing function obtained and of the first key computation parameter.

According to an advantageous characteristic of the invention, in at least one of its embodiments, another piece of computation data is a parameter for re-updating the second computation parameter.

According to a first advantageous embodiment of the invention, the re-updating parameter is a time period of a predetermined duration.

According to a second advantageous embodiment of the invention, with the content comprising packets, the re-updating parameter is a predetermined number of packets encrypted with the second key.

Preferably, the source device according to the invention, in at least one of its embodiments, furthermore comprises:
means for the implementation of a mechanism to increment the second key computation parameter as a function of the re-updating parameter;
means for the re-computation of the second encryption key that are activated after each incrementation of the second key computation parameter.

Advantageously, the source device according to the invention, in at least one of its embodiments, comprises third means for the encryption of the re-updating parameter for the second key computation parameter implementing a third function taking account of the first processing function so as to form a piece of computation data.

Preferably, the means for storing said at least one piece of computation data are implemented locally.

According to an advantageous characteristic of the invention, in at least one of its embodiments, said at least one piece of computation data is the first key computation parameter.

Advantageously, said predetermined piece of information for access to the content to be stored is a password associated with said content and/or said storage device.

Preferably, said content protection protocol is the DTCP protocol.

The invention, in at least one of its embodiments, also relates to a sink device for receiving a content coming from a storage device in order to implement means for reading the content, means for storing the content having been activated by a source device as described here above, said sink device and said storage device implementing a content protection protocol comprising a phase of exchange of a third encryption key associated with a third key computation parameter, the sink device comprising:
means for the reception of a third encrypted content of the storage device, encryption means implementing the third encryption key, having been previously applied to the first encrypted content in order to obtain the third encrypted content;
means for obtaining at least one computation data element;
means for obtaining a second processing function that is a function of a piece of information for authorization of access to the content to be read, said second processing function being identical to said first processing function if the access authorization information corresponds to a predetermined piece of information for access to the stored content;
means for obtaining a second key computation parameter, taking account of said second processing function and said computation data element;
means for computation of the second encryption key, taking account of said second key computation parameter;
first means for decryption of said third encrypted content implementing the third key, used to obtain said first encrypted content, and second means for decryption of said encrypted content implementing the second key used to obtain a non-encrypted content.

Preferably, the sink device comprises:
means to compute the second key computation parameter implementing a first function taking account of the second processing function obtained and the first key computation parameter;
computation means, implementing a second function taking account of said at least one piece of computation data and the second processing function, used to obtain the first key computation parameter.

Advantageously, the means used to obtain said at least one piece of computation data implement means for reading this piece of data, stored in the storage device.

According to a preferred characteristic of the invention, in at least one of its embodiments, at least one of the pieces of computation data is a parameter for re-updating the second key computation parameter.

According to a first advantageous embodiment of the invention, the re-updating parameter is a time period of a predetermined duration.

According to a second advantageous embodiment of the invention, with the content comprising packets, the re-updating parameter is a predetermined number of packets encrypted with the second key.

Preferably, the sink device according to the invention, in at least one of its embodiments, furthermore comprises:
means to implement a mechanism making it possible to increment the second key computation parameter as a function of the re-updating parameter;
means to re-compute the second encryption key after each incrementation of the second key computation parameter.

Advantageously, the means for obtaining said at least one piece of computation data implement means for the retrieval of said at least one piece of computation data in the source device described here above.

According to an advantageous characteristic of the invention, in at least one of its embodiments, said piece of data for authorization of access to the content to be read is a user password.

Preferably, said predetermined piece of information for access to the stored content is a password associated with said content and/or said storage device.

Preferably, said content protection protocol is the DTCP protocol.

### 5. LIST OF FIGURES

Other features and advantages of the invention, in at least one of its embodiments, shall appear from the following description of three particular embodiments of the invention, given by way of non-restrictive and indicative examples, and from the appended drawings, of which:

FIG. 1A is a drawing of an exemplary home audio-video network in which it is possible to implement a storage method and a read method according to the invention;

FIG. 1B illustrates an example of an embodiment of the central switching unit included in the home network of FIG. 1A;

FIG. 1C is a drawing of an implementation of a node of the home network of FIG. 1A according to a particular mode of implementing the invention;

FIG. 2 illustrates the classic DTCP protection protocol implemented during the transmission of a content between a source device and a sink device;

FIG. 3 illustrates a first embodiment of the method of storage of a content c0 according to the invention;

FIG. 4 illustrates a first embodiment of the method for the reading or playback of a content c0 according to the invention;

FIG. 5 illustrates a second and third embodiment of the method for the storage of the content c0 according to the invention;

FIG. 6 illustrates a second and third embodiment of the method for the reading of the content c0 according to the invention;

FIG. 7 is a flow chart of an example of a key management algorithm, executed by a storage management node, in the above-mentioned three embodiments of the storage and read method according to the invention;

FIG. 8 presents the steps implemented by the first node NA during a storage of the content c0 according to the first embodiment of the storage method of the invention;

FIG. 9 presents the steps implemented by the first node NA during a reading of the content c0 according to the first embodiment of the read method of the invention;

FIG. 10 presents the steps implemented by the first node NA during the storage of the content c0 according to the second and third embodiments of the storage method of the invention;

FIG. 11 presents the steps implemented by the first node NA during the reading of the content c0 according to the second and third embodiments of the read method of the invention;

FIG. 12 presents an algorithm for updating the second encryption key, implemented by the first node NA during the storage of the content c0 according to the third embodiment of the invention; and

FIG. 13 presents an algorithm for updating the second encryption key, implemented by the first node NA during the reading of the content c0 according to the third embodiment of the invention.

### 6. DESCRIPTION OF THE THREE EMBODIMENTS OF THE INVENTION

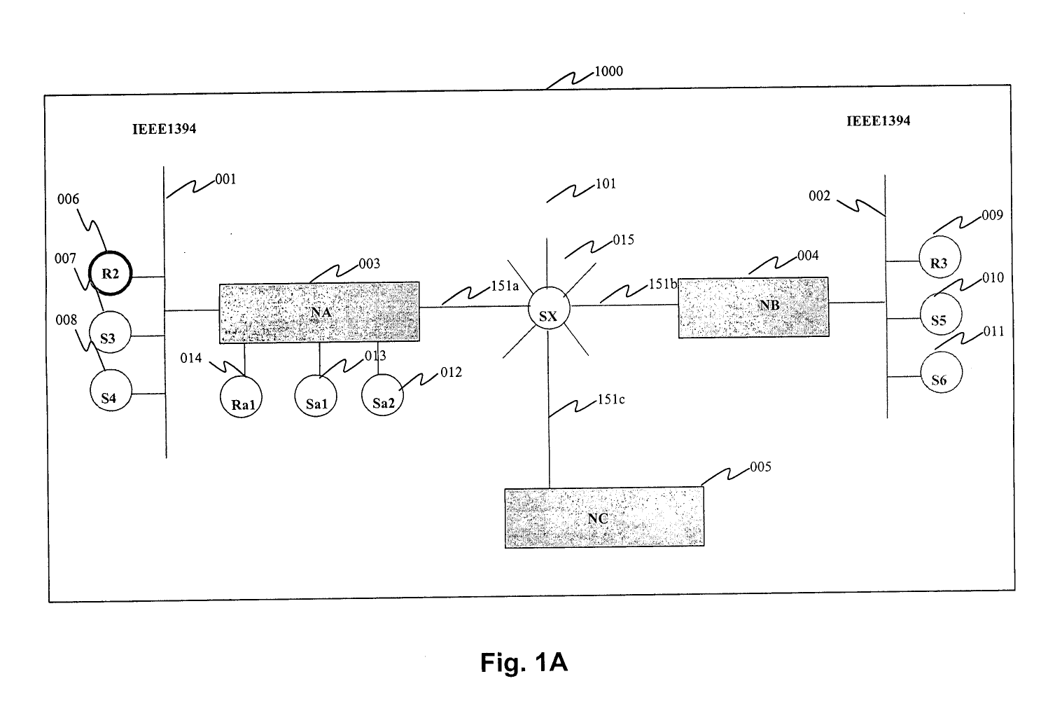

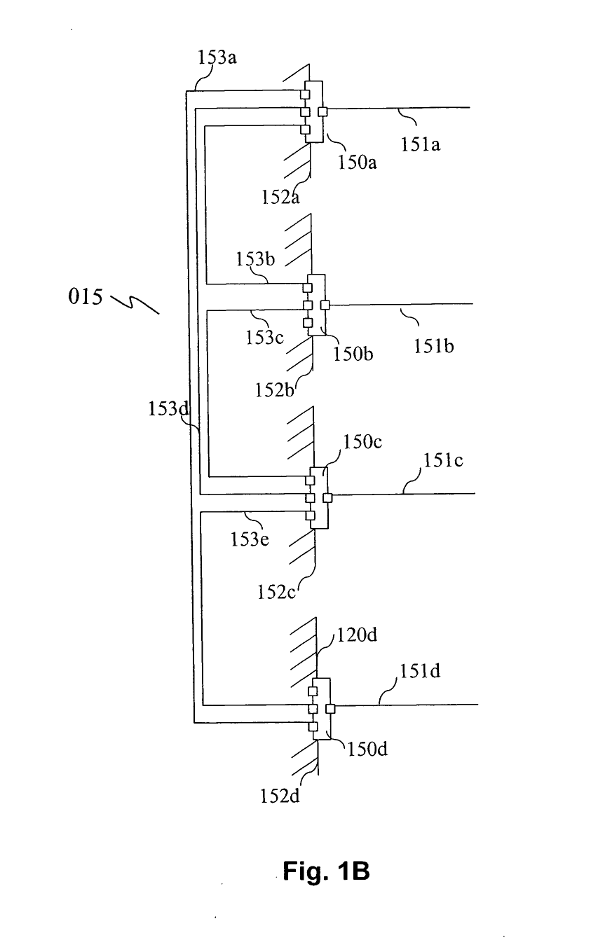

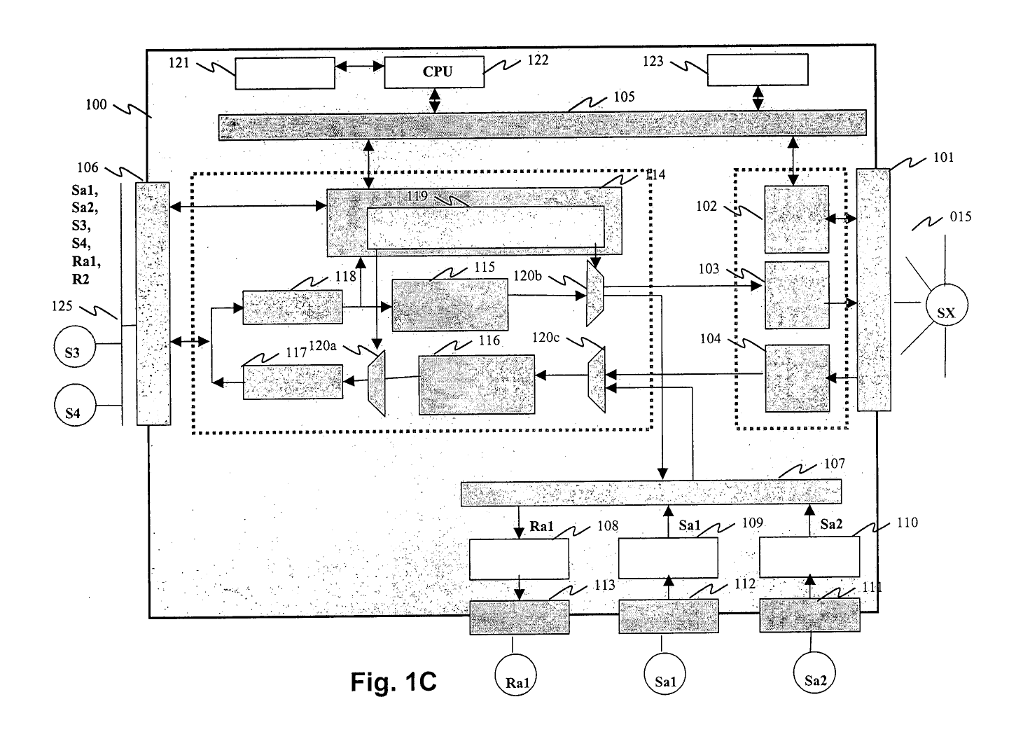

The rest of this description is situated in the context of the home network 1000 of FIG. 1A. However, the invention can be implemented in any communications network comprising at least one storage unit, storing at least one content, connected to at least one sink device.

Furthermore, it is considered here below that the content protection protocol implemented in the home network 1000 is the above-mentioned DTCP protocol. However, it is clear that the invention can also be applied to any content protection protocol comprising an encryption key exchange phase.

By way of an explanatory example, the description shall be situated, here below, in the following particular case: a first user requests the implementation of an operation for the storage of a content c0, from an initial source device, for example the digital videocassette recorder 010 connected to the node NB (hereinafter called a second node) to the storage unit 006, connected to the intermediate source device which is the node NA (hereinafter called a first node).

It is also assumed that the first user assigns a restricted-access status to the content c0.

Then a second user (possibly the same as the first user) wishes to implement an operation for reading or playing back the content c0, with restricted access in the network, so as to play back c0 on a final sink device which is the digital television set 009 connected to the second node NB. The content c0 is stored in the storage unit 006 which is connected to an intermediate sink device which is the first node NA.

By way of an example, we have chosen a particular case in which the intermediate source device and the intermediate sink device are one and the same node, namely the first node NA. It is clear however that, in the other examples, the intermediate source device and the intermediate sink device may be two distinct nodes of a network.

The storage and read methods according to the invention are implemented in the form of a software program and/or a plurality of software sub-programs (comprising a plurality of algorithms described here below) which are executed in several machines of the network 1000, for example in the nodes NA, NB, NC described especially with reference to FIG. 1C.

Referring to FIG. 1C, we present a drawing of an implementation of a node 100 of the home network 1000 according to a particular mode of implementation of the invention. For the sake of simplicity, we shall describe only the generic node 100 which represents both the nodes 003 and the node 004 or even the node 005 of the home network 1000 of FIG. 1A described here above.

The node 100 is connected all at the same time to:
the backbone network 1001 (of which this FIG. 1C shows the central switching unit 015) through a digital link;
an IEEE-1394 bus 125 which is connected to a storage unit; and
analog terminal devices referenced Ra1, Sa1 and Sa2 through analog links.

The node 100 has a backbone network interface 101 with the backbone network 1001 used by the home network controller 102 in order to transmit and/or receive packets on and/or coming from the backbone network 1001. The backbone network controller 102 also manages the format of these packets.

In the node 100, there is a transmission buffer memory 103 implemented for the transmission of data on the network and a reception buffer memory 104 for the reception of data coming from the network.

A microprocessor interface module 105 has the task of setting up the interface with the microprocessor (referenced CPU or central processing unit) 122 in order to decode the CPU register and implement the DMA (direct memory access) transfers managed by the microprocessor 122 from or to the SDRAM (Synchronous Dual Random Access Memory) memory block 121.

A serial bus interface module 106 sets up the physical layer interface and link interface of the IEEE-1394 bus in complying with the IEEE-1394 standard.

An audio-video interface module 107 carries out the formatting and de-formatting of the packets of the IEEE-1394 streams sent on the IEEE bus according to the recommendations of the following document: “IEC Std 61883, Consumer audio/video equipment—Digital interface”.

The node 100 also has MPEG2 decoders/encoders 108, 109, 110 respectively connected to audio-video input/output ports 113, 112 and 111 which are themselves connected respectively to the analog terminals Ra1, Sa1 and Sa2.

A transition control module 114 provides for the following:
the implementation of all the critical operations at a temporal level associated with the IEEE-1394 bridge (as described in the following reference document: “IEEE P1394.1 Draft 0.15 Standard for High Performance Serial Bus Bridges”) including especially:
   the monitoring of the incoming packets;
   the generation of acknowledgment messages;
   the management of the isochronous and a synchronous routing;
   the synchronization of the IEEE-1394 clock;
the management of the isochronous transfer requests between:
   the serial bus interface 106 and the backbone interface 101;
   the serial bus interface 106 and the microprocessor interface 105;
the implementation of the following operations on the stream headers when necessary:
   elimination;
   insertion request;
   time-stamping;
the reception of all the interface signals linked to the “status and interrupt signals interface) of the serial bus interface 106;
the reception of all the interface signals linked to the “PHY Register Access Interface Signals” of the serial bus interface 106;
the management of the transmission and reception of the packets of the contents.

The node 100 includes a decryption node 115 which implements the decryption of certain contents when it is authorized to do so.

It includes an encryption module 116 that implements the encryption of certain contents when invited to do so.

It also includes a FIFO (first-in first-out) isochronous transmission module 117 which implements an isochronous 2K×32 bit FIFO.

It also includes an isochronous reception FIFO module 118 which implements an isochronous 2K×32 bit FIFO.

It also includes a key management module 119 which generates encryption and decryption keys used for encryption or decryption by the encryption module 116. The key management module 119 controls the double encryption or decryption method according to the invention.

It also includes multiplexing modules 120a to 120c. The multiplexing module 120a is controlled by the key management module 119 and enables the routing of a data stream, once encrypted, to the isochronous transmission FIFO module 117 or the routing of a data stream to the input of the encryption module 116 when a second encryption is necessary.

The multiplexing module 120b is controlled by the key management module 119 and enables the routing of a data stream, once decrypted, to the transmission buffer memory 103 or to the audio-video interface module 107 or even the routing of a data stream to the input of the decryption module 115 when a second decryption is necessary.

The node 100 also has a flash memory unit 123 connected to the microprocessor interface module 105.

According to a particular example of an implementation of the invention, each restricted-access content stored in the network has a corresponding content private key (referenced CPK) forming a reference password specific to this content.

According to a variant of this particular example of implementation, all the restricted-access contents stored in the network have a corresponding single content private key (referenced CPK) forming a reference password common to all the contents.

According to another variant of this particular example of an implementation, it is not the restricted-access contents that have an associated content private key (CPK) forming a reference password but the storage units in which these restricted-access contents are stored.

For example, each storage unit may have a distinct private key associated with it. In another example, one and the same private key is associated with all or only a part of the storage units.

A table of the contents and their access restriction is also implemented in this preferred mode of implementation of the invention. This table especially has all the contents stored in the network 1000 as well as, for each of the contents, a piece of information indicating whether or not it is restricted-access information. Here below, this piece of information shall be called the content restriction status.

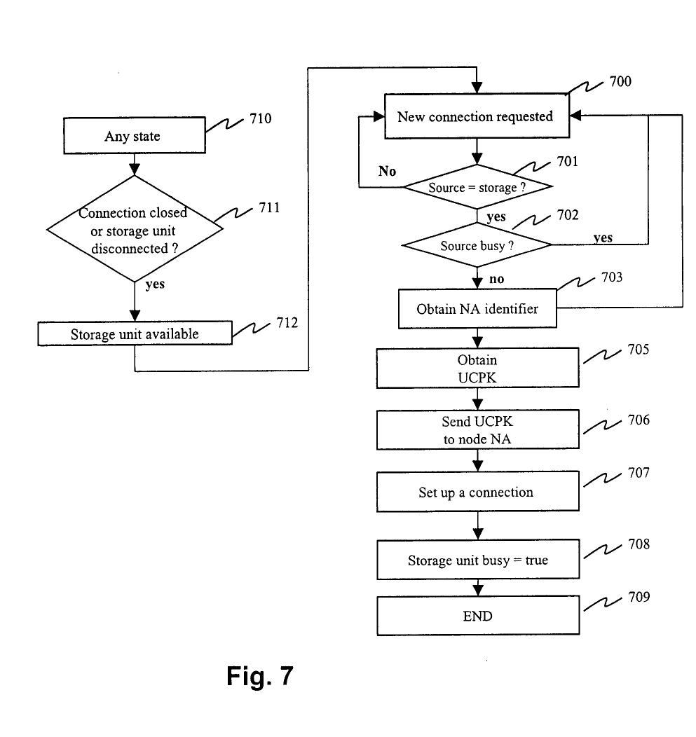

This table of contents is, for example, included in a storage management node or in each node of the network, as explained here below with reference to FIG. 7.

For example, this table includes the name of each content, the restriction status, the content private key of each content (CPK) as well as an identifier of the storage unit on which each content is stored.

According to a preferred characteristic of the invention, a graphic interface enables the users to transmit their instructions to the devices of the network 1000.

This interface is used especially during a step of configuration of the network, in which a user decides to assign an access restriction status as well as a possible content private key for each content of the network 1000. This configuration step may be implemented prior to the use of the network and/or may be implemented whenever a new content is introduced for storage in the network 1000.

In other words, in the second case, during the storage operation, the user enters a password (CPK) which is used to compute a first mask during the storage operation and then enters a second password (UCPK) which is used to compute a second mask during the read operation.

The above-mentioned table of contents is filled by means of the graphic interface during the configuration steps.

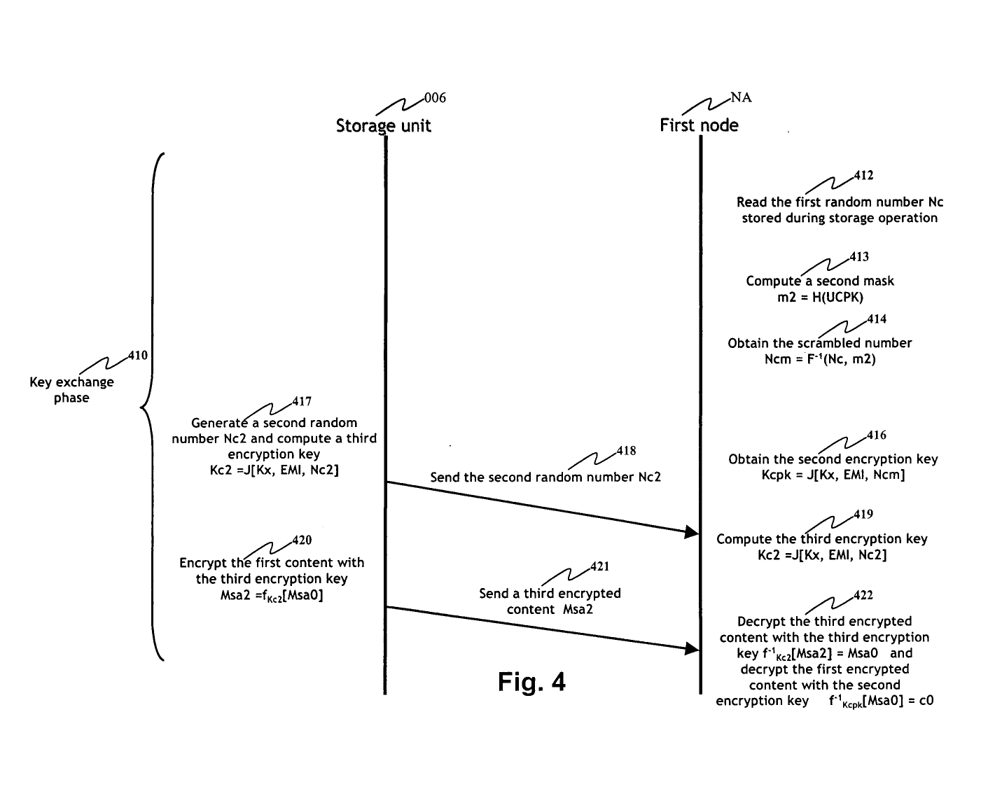

This interface is furthermore used when the second user wishes to implement the read operation. Indeed, prior to this read operation, the second user is asked to enter a password, hereinafter called a user content private key referenced UCPK. As explained in detail here below, with reference to FIG. 4 especially, if the entered password (UCPK) corresponds (either identically or according to a predefined function) to the reference password (CPK), the second user is authorized to access the content.

The devices of the network 1000 comprise means to know whether the contents of the network 1000 are free-access or restricted-access contents. For example, they provide access to the above-mentioned table of contents.

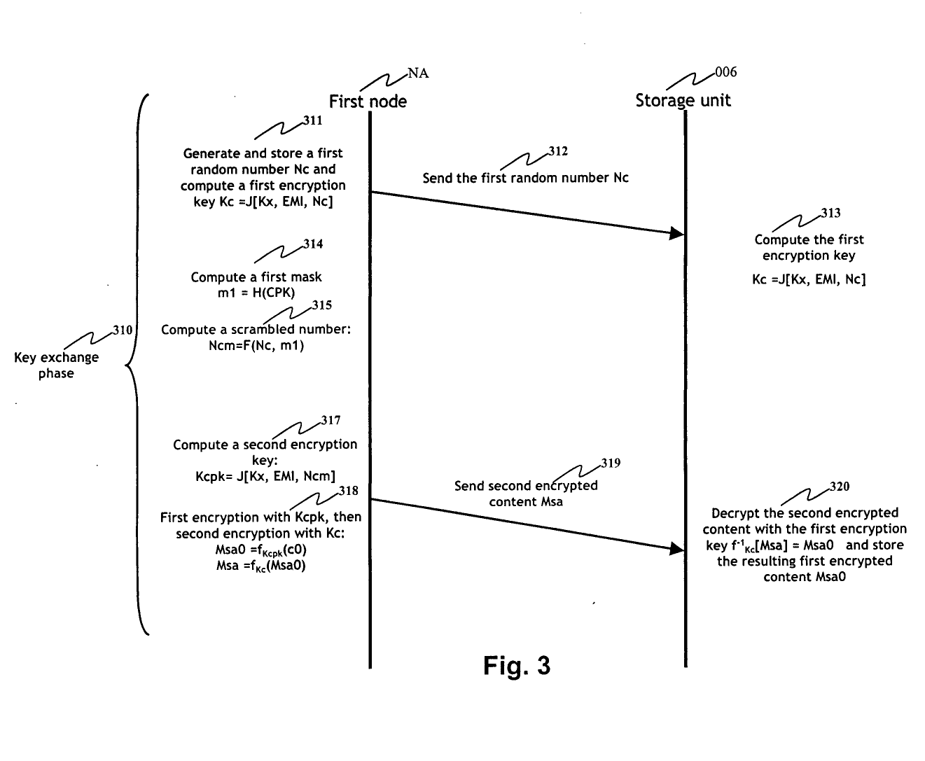

FIG. 3 illustrates a first embodiment of the storage method of the content c0 according to the invention implemented during the operation of storage of the above-mentioned content c0.

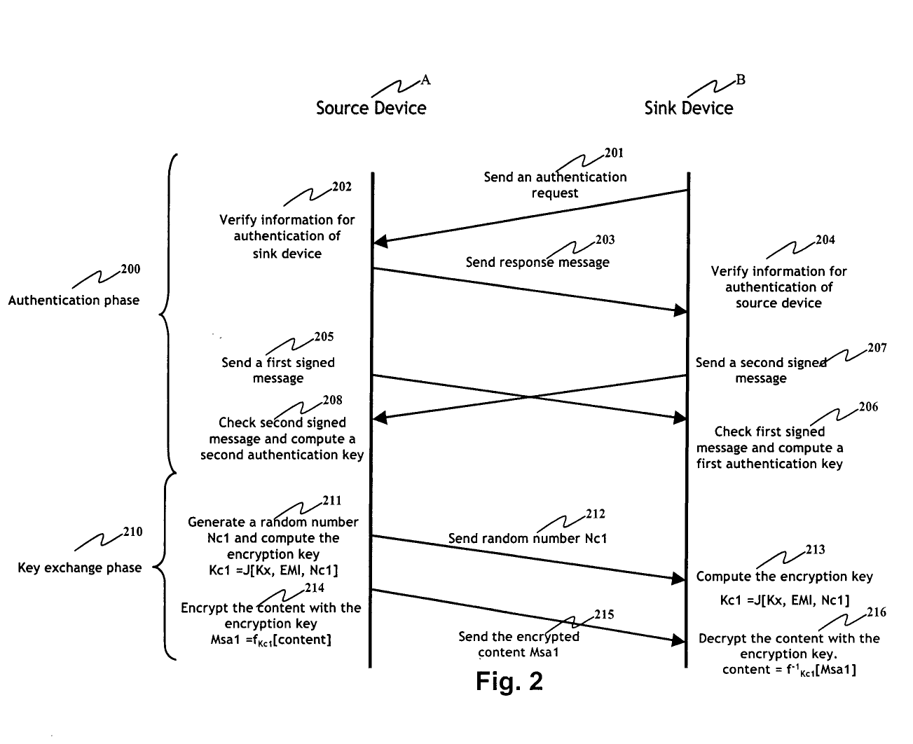

During the operation of storage of the content c0, before the storage proper of c0 in the storage unit, the following are implemented:
a first transmission of the content c0 from the digital videocassette recorder 010 to the first node NA by means of the classic DTCP protocol or any other technique for securing the transmission of a stream in a communications network;
a second transmission of the content c0 from the first node NA (playing the role of the source device of FIG. 2) to the storage unit 006 (playing the role of the sink device of FIG. 2).

During this second transmission, a phase of authentication between the first node NA and the storage unit 006 is implemented. It is identical to the authentication phase 200 of the classic DTCP protocol (described here above with reference to FIG. 2).

On the contrary, the key exchange phase 310 implemented is different from the key exchange phase of the classic DTCP protocol. FIG. 3 provides a more particular illustration of this modified key exchange phase 310 which comprises the following steps:
in a first step 311, the first node NA generates and stores a first key computation parameter, for example a first random number Nc which, in this embodiment, will also be a piece of computation data used in the read method. The first node NA computes a first encryption key Kc which is a function especially of the first random number Nc and verifies Kc=J[Kx, EMI, Nc] where J is a determined function, EMI and Kx are classic parameters of the DTCP protocol;
in a second step 312, the first random number Nc is sent by the first node NA to the storage unit 006;
in a third step 313, the storage unit 006 computes the first encryption key Kc by means of the first random number Nc;
in a fourth step 314, the first node NA computes a first processing function m1, hereinafter called a first mask, from the content private key CPK, according to the relationship m1=H(CPK) where H is a determined function;
in a fifth step 315, the first node NA makes a computation, from the first random number Nc and the first mask m1, of a second key computation parameter hereinafter called a scrambled number Ncm according to the relationship Ncm=F(Nc, m1) where F is a determined function;
in a sixth step 317, the first node NA computes a second encryption key Kcpk which is a function especially of the scrambled number Ncm and which verifies Kcpk=J[Kw, EMI, Ncm];
in a seventh step 318, the first node NA performs a first encryption of the content c0 by means of the second key Kcpk so as to obtain a first encrypted content msa0 according to the relationship: Msa0=f_{Kcpk}(c0) where f_{Kcpk} is a determined function and then performs a second encryption of the first encrypted content Msa0 by means of the first key Kc so as to obtain a second encrypted content Msa according to the relationship: Msa=f_{Kc}(Msa0) where f_{Kc} is a determined function; the second encrypted content Msa is therefore doubly encrypted (it has undergone a twofold encryption);
in an eighth step 319, the first node NA sends the storage unit the second encrypted content Msa;
in a ninth step 320, the storage unit 006 decrypts (according to the relationship f_{Kc}⁻¹ (Msa)=Msa0 where f_{Kc}⁻¹ is the reciprocal function of the function f_{Kc}) the second encrypted content Msa by means of the first encryption key Kc so as to obtain the first encryption content Msa0, and then stores the resulting first encrypted content.

FIG. 4 illustrates a first embodiment of the method for reading the content c0 according to the invention, implemented during the above-mentioned operation for reading the content c0.

During the operation for reading the content c0, before the reading proper of the content c0 on the digital television 009, the following are implemented:
a first transmission of the content c0 stored on the storage unit 006 (playing the role of the source device of FIG. 2) to the first node NA (playing the role of the sink device of FIG. 2);
a second transmission of the content c0 from the first node NA to the digital television set 009 by means of a classic DTCP protocol or by any other technique for securing the transmission of a stream in a communications network.

During the first transmission, a phase of authentication between the first node NA and the storage unit 006 is implemented. It is identical to the authentication phase 200 of the classic DTCP protocol (described here above with reference to FIG. 2).

On the contrary, the key exchange phase 410 implemented is different from the key exchange phase of the classic DTCP protocol. FIG. 4 also provides a more particular illustration of this modified key exchange phase 410 which comprises the following steps:
in a first step 412, the first node NA reads the computation data corresponding here to the random number Nc which has been previously stored (first step 311 mentioned here above) during the operation for storage of the content c0;
in a second step 413, the first node NA computes a second processing function m2 hereinafter called a second mask, from the user content private key UCPK (transmitted to the first node NA by the storage management node described here below with reference to FIG. 7), according to the relationship m2=H(UCPK). If the user content private key UCPK (which is also the password entered by the user) corresponds to the content private key (which is also the reference password), it means that the second user knows the right password to be entered (UCPK), and is therefore authorized to have read access to the content c0. In this case, the function m2 is identical to the function m1 used during storage;
in a third step 414, the first node NA obtains the scrambled number Ncm in using the above-mentioned function F applied to the computation data corresponding to the first random number Nc and to the second mask m2 according to the relationship Ncm=F(Nc, m2);
in a fourth step 416, the first node NA obtains the second encryption key Kcpk in using the above-mentioned function J applied to the scrambled number Ncm and to the parameters of the classic DTCP protocol Kx and EMI according to the relationship Kcpk=J[Kw, EMI, Ncm];
in a fifth step 417, the storage unit 006 generates a third key computation parameter, in this case a random piece of information, for example a second random number Nc2 and computes a third encryption key Kc2 which is a function especially of the second random number Nc2 and verifies Kc2=J[Kx, EMI, Nc2];
in a sixth step 418, the storage unit 006 sends the first node NA the second random number Nc2;
in a seventh step 419, the first node NA computes the third encryption key Kc2;
in an eighth step 420, the storage unit 006 encrypts (according to the relationship f_{Kc2} (Msa0)=Msa2 where f_{Kc2} is the determined function) the first encrypted content Msa0 by means of the third encryption key Kc2 so as to obtain a third encrypted content Msa2;
in a ninth step 421, the storage unit 006 sends the first node NA the third encrypted content Msa2;
in a tenth step 422, the first node NA decrypts (according to the relationship f_{Kc2}⁻¹ (Msa2)=Msa0 where f_{Kc2}⁻¹ is the reciprocal function of the function f_{Kc2}), the third encrypted content Msa2 by means of the third encryption key Kc2 so as to obtain the first encrypted content Msa0. Then, once again (according to the relationship f_{Kcpk}⁻¹ (Msa0)=c0 where f_{Kcpk}⁻¹ is the reciprocal function of the function f_{Kcpk}), the node NA decrypts the first resulting encrypted content Msa0 by means of the second encryption key Kcpk so as to retrieve the content c0 (the content c0 therefore undergoes a double decryption).

If the user content private key UCPK does not correspond to the content private key CPK, it means that the second user does not know the right password to be entered and is therefore not authorized to obtain read access to the content c0. Then, the third and fourth steps 414, 416 cannot be used to obtain the scrambled number Ncm or the second encryption key Kcpk because the processing functions m2 and m1 are not identical. Consequently, the first encrypted content Msa0 is not decrypted in the tenth step 422 and the user cannot play back the content c0.

In this first embodiment, the reading of the content is made conditional on the fact that this reading must be done on the node NA which has stored the content since it is this node that has stored the computation data. This embodiment therefore offers restricted-access control at the level of a node.

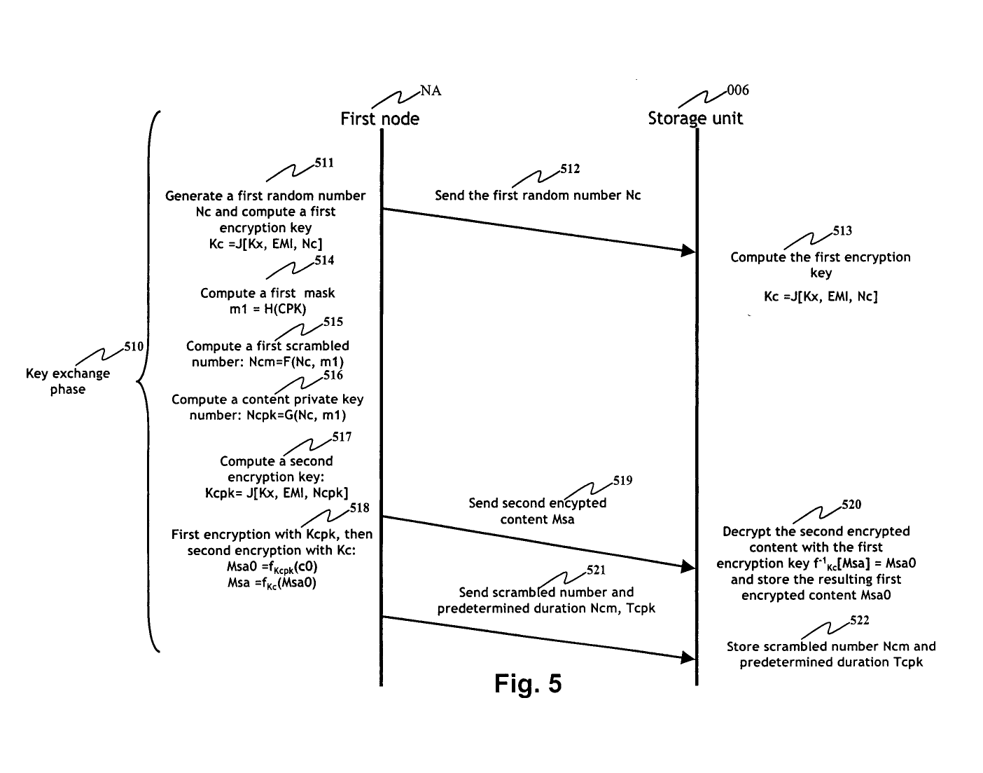

FIG. 5 illustrates a second embodiment and a third embodiment of the method for storing the content c0 according to the invention, implemented during the above-mentioned operation for storage of the content c0.

Here below, only the third embodiment of the storage method shall be described, given that the second embodiment is identical to the third embodiment except that, in the second embodiment, the predetermined duration Tcpk is not brought into play. This means that the predetermined duration Tcpk:
is not transmitted from the first node NA to the storage unit 006 in the eleventh step 521 described here below, and
is not stored in the storage unit 006 in the twelfth step 522 described here below.

During the content storage operation c0, before the storage proper of c0 on the storage unit, the following operations are implemented:
a first transmission of the content c0 from the digital videocassette recorder 010 to the first node NA by means of the classic DTCP protocol or any other technique for securing the transmission of a stream in a communications network;
a second transmission of the content c0 from the first node NA (playing the role of the source device of FIG. 2) to the storage unit 006 (playing the role of the sink device of FIG. 2).

During this second transmission, a phase of authentication between the first node NA and the storage unit 006 is implemented. It is identical to the authentication phase 200 of the classic DTCP protocol (described here above with reference to FIG. 2).

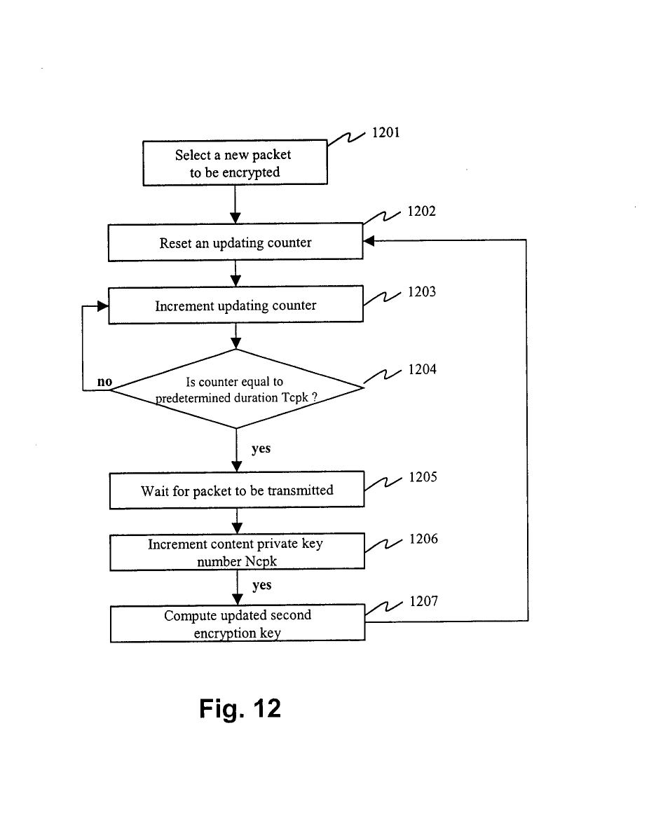

On the contrary, the key exchange phase 510 implemented is different from the key exchange phase of the classic DTCP protocol. FIG. 5 provides a more particular illustration of this modified key exchange phase 310 which comprises the following steps:
in a first step, the first node NA generates a first key computation parameter, in this case a piece of random information, for example a first random number Nc and computes a first encryption key Kc which is a function especially of the first random number Nc and which verifies Kc=J[Kx, EMI, Nc] where J is a determined function, EMI and Kx are classic parameters of the DTCP protocol;
in a second step 512, the first random number Nc is sent by the first node NA to the storage unit 006;
in a third step 513, the storage unit 006 computes the first encryption key Kc by means of the first random number Nc;
in a fourth step 514, the first node NA computes a first processing function m1, hereinafter called a first mask, from the content private key CPK, according to the relationship m1=H(CPK) where H is a determined function;
in a fifth step 515, the first node NA makes a computation, from the first random number Nc and the first mask m1, of a second key computation parameter hereinafter called a scrambled number Ncm according to the relationship Ncm=F(Nc, m1) where F is a determined function;
in a sixth step 516, the first node NA makes a computation, from the first random number Nc and the first mask m1, of a second key computation parameter hereinafter called a content private key number Ncpk according to the relationship Ncpk=G(Nc, m1) where G is a determined function;
in a seventh step 517, the first node NA computes a second encryption key Kcpk which is a function especially of the content private key number Ncpk and which verifies Kcpk=J[Kx, EMI, Ncpk];
in an eighth step 518, the first node NA performs a first encryption of the content c0 by means of the second key Kcpk so as to obtain a first encrypted content msa0 according to the relationship: Msa0=f_{Kcpk}(c0) where f_{Kcpk} is a determined function and then performs a second encryption of the first encrypted content Msa0 by means of the first key Kc so as to obtain a second encrypted content Msa according to the relationship: Msa=f_{Kc}(Msa0) where f_{Kc} is a determined function, the second encrypted content Msa is therefore doubly encrypted (it has undergone a twofold encryption);
in a ninth step 519, the first node NA sends the storage unit the second encrypted content Msa;
in a tenth step 520, the storage unit 006 decrypts (according to the relationship f⁻¹_{Kc} (Msa)=Msa0, where f⁻¹_{Kc} is the reciprocal function of the function f_{Kc}) the second encrypted content Msa by means of the first encryption key Kc so as to obtain the first encryption content Msa0, and then stores the resulting first encrypted content.
in the eleventh step 521, the first node NA sends the storage unit the scrambled number Ncm and a predetermined duration Tcpk which shall be described here below with reference to FIG. 12. These pieces of data are computation data which shall be used during the read method;
in a twelfth step 522, the storage unit stores the computation data, namely the scrambled number Ncm as well as the predetermined duration Tcpk.

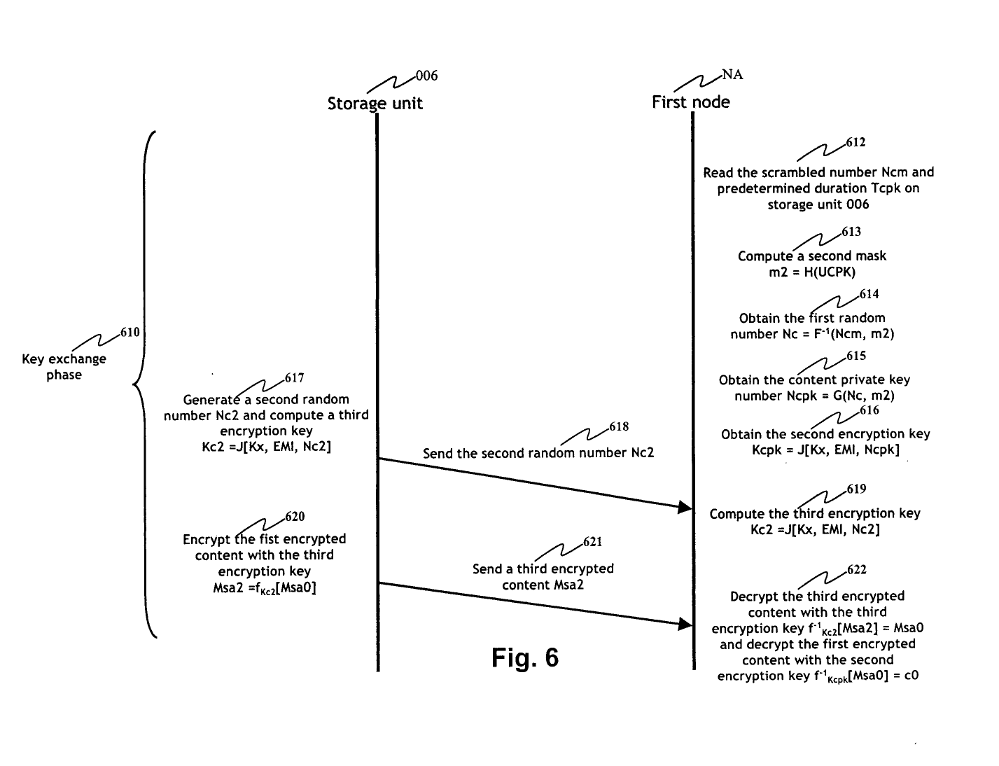

FIG. 6 illustrates a second embodiment and a third embodiment of the method for reading the content c0 according to the invention, implemented during the above-mentioned operation for storage of the content c0.

Here below, only the third embodiment of the read method shall be described, given that the second embodiment is identical to the third embodiment except that in the second embodiment, the predetermined duration Tcpk is not brought into play. This means that the predetermined duration Tcpk is not read by the first node NA on the storage unit 006 in the first step 612 described here below.

During the operation for reading the content c0, before the operation proper for reading the content c0 on the digital television set 009, the following operations are implemented:
a first transmission of the content c0, stored in the storage unit 006 (playing the role of the source device of FIG. 2) to the first node NA (playing the role of the sink device of FIG. 2);
a second transmission of the content c0 from the first node NA to the digital television set 009 by means of the classic DTCP protocol or by any other technique for securing the transmission of a stream in a communications network.

During the first transmission, a phase of authentication between the first node Na and the storage unit 006 is implemented. It is identical to the authentication phase 200 of the classic DTCP protocol (described here above with reference to FIG. 2).

On the contrary, the key exchange phase 610 implemented is different from the key exchange phase of the classic DTCP protocol. FIG. 6 provides a more particular illustration of this modified key exchange phase 610 which comprises the following steps:
in a first step 612, the first node NA reads the computation data on the storage unit 006, namely the scrambled number Ncm and the predetermined duration Tcpk previously stored (twelfth step 522) during the operation for the storage of the content c0;
in a second step 613, the first node NA computes a second processing function m2 hereinafter called a second mask from the user content private key UCPK (transmitted to the first node NA by a storage management node described here below with reference to FIG. 7), according to the relationship m2=H(UCPK. If the user content private key UCPK (which is also the password entered by the user) corresponds to the content private key (which is also the reference password), it means that the second user knows the right password to be entered (UCPK) and is therefore authorized to obtain read access to the content c0;
in a third step 614, the first node NA obtains the first random number Nc in using the reciprocal function F¹ of the above-mentioned function F applied to the scrambled number Ncm and to the second mask m2 according to the relationship Nc=F¹(Ncm, m2);
in a fourth step 615, the first node NA obtains the second key computation parameter Ncpk in using the above-mentioned function G applied to the first random number Nc and to the second mask m2 according to the relationship Ncpk=G(Nc, m2);
in a fifth step 616, the first node NA obtains the second encryption key Kcpk in using the above-mentioned function J applied to the number of the content private key Ncpk and to the parameters of the classic DTCP protocol Kx and EMI according to the relationship Kcpk=J[Kx, EMI, Ncpk];
in a sixth step 617, the storage unit 006 generates a third key computation parameter, in this case a random piece of information, for example a second random number Nc2 and computes a third encryption key Kc2 which is a function especially of the second random number Nc2 and verifies Kc2=J[Kx, EMI, Nc2];
in a seventh step 618, the storage unit 006 sends a first node NA the second random number Nc2;
in an eighth step 619, the first node NA computes the third encryption key Kc2;
in a ninth step 620, the storage unit 006 encrypts (according to the relationship f_{Kc2} (Msa0)=Msa2 where f_{Kc2} is the determined function) the first encrypted content Msa0 by means of the third encryption key Kc2 so as to obtain a third encrypted content Msa2;
in a tenth step 621, the storage unit 006 sends the first node NA the third encrypted content Msa2;
in an eleventh step 622, the first node NA decrypts (according to the relationship f⁻¹_{Kc2} (Msa2)=Msa0 where f⁻¹_{Kc2} is the reciprocal function of the function f_{Kc2}), the third encrypted content Msa2 by means of the third encryption key Kc2 so as to obtain the first encrypted content Msa0. Then, once again (according to the relationship f⁻¹_{Kcpk} (Msa0)=c0 where f⁻¹_{Kcpk} is the reciprocal function of the function f_{Kcpk}), the node NA decrypts the first resulting encrypted content Msa0 by means of the second encryption key Kcpk so as to retrieve the content c0 (the content c0 therefore undergoes a double decryption).

If the user content private key UCPK does not correspond to the content private key CPK, it means that the second user does not know the right password to be entered and is therefore not authorized to obtain read access to the content c0. Then, the third, fourth and fifth steps 614, 615, 616 cannot be used to obtain the scrambled number Nc or the private content key number Ncpk or the second encryption key Kcpk because the processing functions m2 and m1 are not identical. Consequently, the first encrypted content Msa0 is not decrypted in the eleventh step 622 and the user cannot read the content c0.

The second embodiment presented therefore offers content access control for nodes of the network implementing the invention. The fact that the computation data Ncm is stored on the storage device and not on the node having performed the storage makes it possible to access the content from any network node whatsoever that implements the invention. The fact of using the scrambled number Ncm and the private number Ncpk, provides additional security for access control.

Referring to FIG. 7, a flow chart is presented of an example of a key management algorithm executed by a storage management node which, for example, is the node NC, in the above-mentioned first, second and third embodiments of the storage and reading methods according to the invention.

In one mode of implementation of the invention, the management of the keys is centralized in the node NC which is the only node of the network to play the role of a storage management node. To do this, it comprises the above-mentioned contents table.

This key management algorithm is implemented especially when:
the first user launches the above-mentioned operation for the storage of the content c0 coming from the digital videocassette recorder 010 (initial source device) to the storage unit 006;
the second user launches the above-mentioned operation for reading the content c0, stored in the storage unit 006, on the digital television set 009 (final sink device).

Here below, this algorithm shall be described in the case of the implementation of the above-mentioned read operation.

In a first step 700, the connection of a final sink device (for example the digital television set 009) with a source device of the network 1000 is required, in order to access a content c0. In a second step 701, the storage management node NC ascertains that the source device is a storage unit.

If the source device is not a storage unit, the read method according to the invention is not implemented, the storage management node NC returns to the first step 700 and waits for a new connection to be requested.

If the source device is a storage unit, for example the storage unit 006, in a third step 702, the storage management node NC ascertains that the storage node 006 is not busy (namely that it is not being used by other devices of the network 1000 in such a way that it no longer has an output port available for reading).

If the storage unit 006 is busy, the connection is rejected and the storage management node NC returns to the first step 700.

If not (i.e. if at least one read output port is available), then in a fourth step 703, the storage management node NC obtains an identifier of the first node NA to which the storage unit 006 is connected.

At the same time, in a sixth step 705, the user content private key (UCPK) of c0 is obtained (after the user has entered the password as explained here above).

In a seventh step 706, the storage management node NC sends the first node NA the user content private key (UCPK) associated with c0.

In the implementation of the content c0 storage operation, which is not shown, the above-mentioned steps 705 and 706 are replaced by a step for sending the content private key CPK associated with the content c0 to the first node NA (after it has been extracted from the contents table by the storage management node NC).

In an eighth step 707, a connection is set up between the first node NA and the storage unit 006 and, in a ninth step 708, the storage unit is identified as being busy (if it no longer has any output port available following this connection) or one of its output ports is identified as being busy (if it has at least one output port available following this connection).

Then, the storage management node NC puts an end to the running of this key management method, in a tenth step 709.

At any time (eleventh step 710), if the connection between the storage unit 006 and the first node NA is closed, or if the storage unit 006 is disconnected (an eleventh step 711 seeks to determine whether at least one of these condition is verified), the storage unit 006 is identified as being available (because at least one of its read output ports becomes available) in a thirteenth step 712. Then the storage management node NC returns to the first step 700.

This key management and connection management method is implemented for each source device that a final sink device wishes to access, and for each corresponding connection. It is also implemented for each storage device that a final source device wishes to access, and for each corresponding connection.

Here, the node NC plays the role of the storage management node. In practice, and as the case may be, each node NA, NB, NC may play the role of a sink node or requesting node.

In one variant of this first mode of implementation of the invention, the management of keys is not centralized in a specific node but is distributed in every node of the network 1000. Then each node comprises or has access to a table of content. In other words, for a transmission of contents, each node of the network plays its role (of sink node or requesting node) as well as the role of storage management node. In this variant, the fourth step 703, fifth step 704 and seventh step 706 of the private key management method are not implemented.

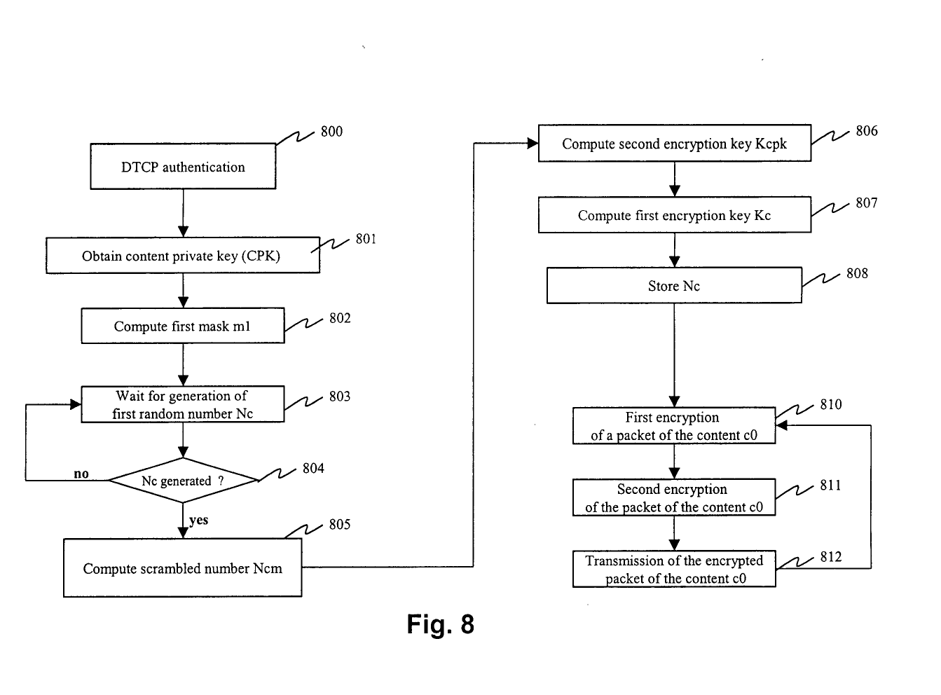

A description has been given here above, with reference to FIG. 3, of the steps of the method for the storage of the content c0 according to a first embodiment of the invention. Referring now to FIG. 8, a description shall be given of the steps implemented by the first node NA when the storage method illustrated in FIG. 3 is executed.

It may be noted that the order of the steps implemented by the first node NA, described with reference to FIG. 8, does not correspond perfectly to the order of the steps pertaining to this first node NA, described with reference to FIG. 3. Indeed, the order of certain steps is of little importance.

After the authentication phase DTCP has been implemented (step 800), the first node NA obtains the content private key CPK (step 801) transmitted by the storage management node NC. Then, the first mask m1 is computed (step 802).

Then, a waiting step in which the first node. NA waits for the generation of the first random number Nc is implemented (step 803), and is followed by a step for verifying that the first random number Nc has been generated (step 804). If the first random number Nc has not yet been generated, the waiting step 803 is again implemented.

Once the first random number Nc has been generated by the first node NA, the first mask m1 is applied to the first random number Nc to compute the scrambled number Ncm (second key computation parameter) (step 805).

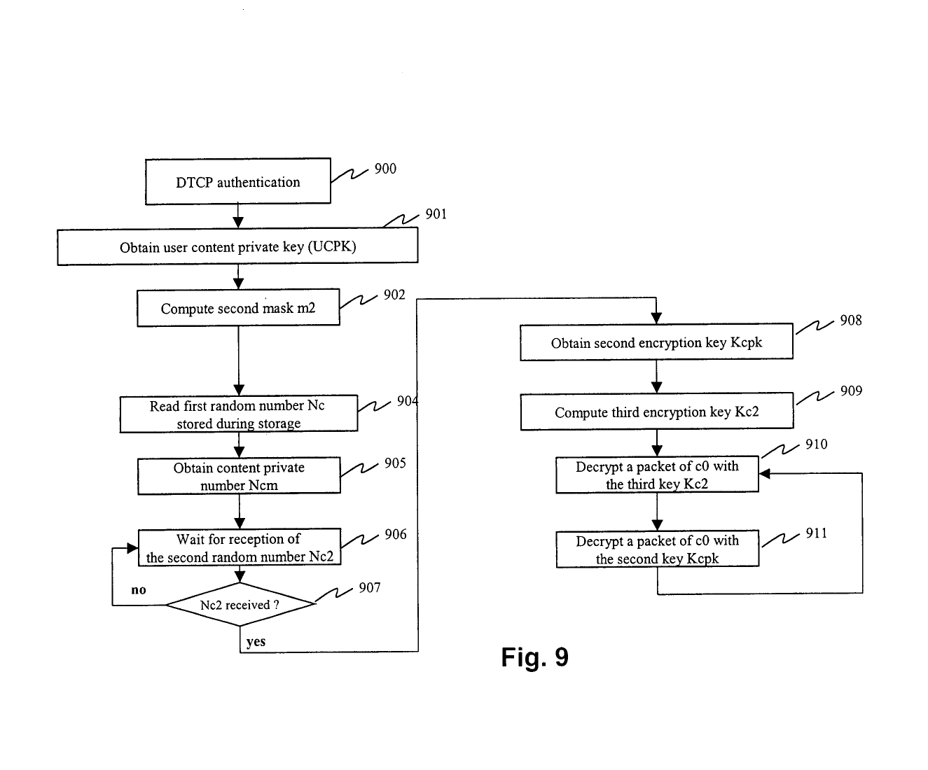

Then the second encryption key Kcpk (step 806) as well as the first encryption key Kc (step 807) are computed by the first node NA. Then, in a step 808, the first node NA stores the random number Nc as a piece of computation data that will be used for the read method described with reference to FIG. 9.

Then, a first packet of the content c0 undergoes the first encryption with the second encryption key (step 810) and a second encryption with the first encryption key (step 811) by the first node NA. Thus, each of the packets of the content c0 undergoes a double encryption implemented by the first node NA before being transmitted to the storage unit.

Then, the first node NA transmits this first packet to the storage unit 006 (step 812) before re-implementing the steps of double encryption 810, 811 and transmission 812 successively for each of the other packets of the content c0 so that the entire encrypted content c0 is received by the storage unit 006.

A description has been given here above, with reference to FIG. 4, of the steps of the method for reading the content c0 according to a first embodiment of the invention. Referring now to FIG. 9, a description shall be given of the steps implemented by the first node NA when the storage method illustrated in FIG. 4 is executed.

It may be noted that the order of the steps implemented by the first node NA, described with reference to FIG. 9, does not correspond perfectly to the order of the steps pertaining to this first node NA, described with reference to FIG. 4. Indeed, the order of certain steps is of little importance.

After the authentication phase DTCP has been implemented. (step 900), the first node NA obtains the user content private key UCPK (step 901) transmitted by the storage management node NC. Then, the second mask m1 is computed (step 902).

Then, a step for reading the computation data, in this case the first random number Nc, is implemented by the first node NA (step 904).

Then, the scrambled number Ncm (second computation key parameter) (step 905) is obtained by the first node NA.

Then, a waiting step in which the first node NA waits for the reception of the second random number Nc2 (generated and then transmitted to the first node NA by the storage unit 006) is implemented (step 906), and is followed by a step for verifying that the second random number Nc2 has been received by the first node NA (step 907). If the second random number Nc2 has not yet been received, the waiting step 907 is again implemented.

Once the second random number Nc2 has been received by the first node NA, the first node NA obtains the second encryption key Kcpk (step 908) and computes the third encryption key Kc2 (step 909).

Then a first content packet c0 is decrypted with the third encryption key Kc2 (step 910) and decrypted with the second encryption key Kcpk (step 911) by the first node NA.

Then the first node NA re-implements the decryption steps 910, 911 successively for each of the other packets of the content c0 so that the entire content c0 is totally decrypted (clear) and can be transmitted to the second node NB and then to the digital television set 009 to implement the read operation proper.

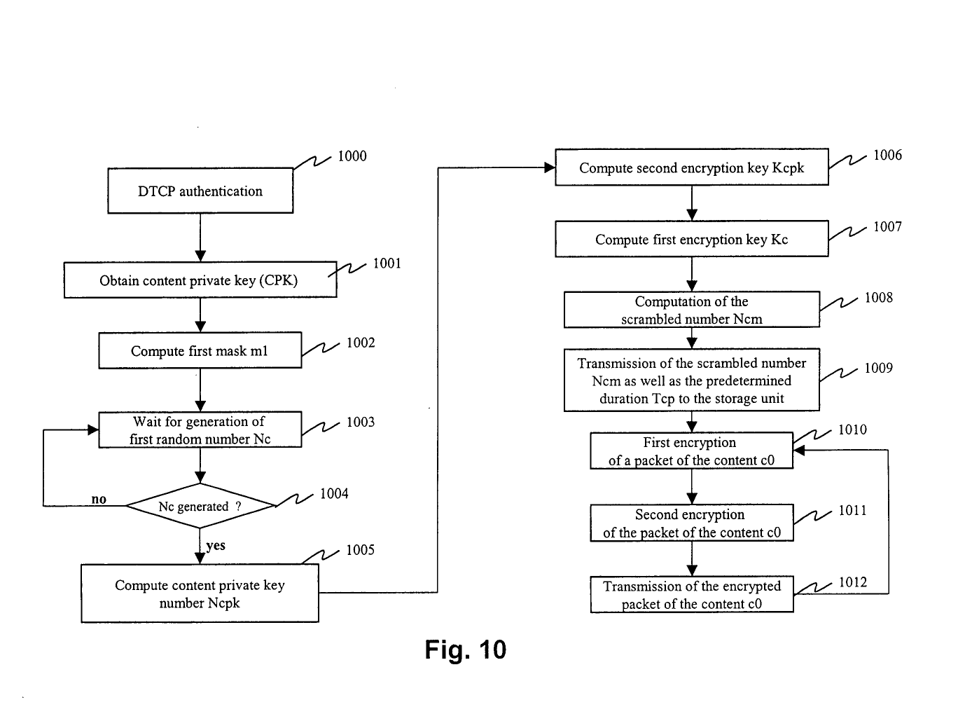

A description has been given here above, with reference to FIG. 5, of the steps of the method for reading the content c0 according to the second and third embodiments of the invention. Referring now to FIG. 10, a description shall be given of the steps implemented by the first node NA when the storage method illustrated in FIG. 5 is executed.

Just as in the case of FIG. 5, only the third embodiment of the storage method shall be described here below, given that the second embodiment is identical to the third embodiment except that in the second embodiment, the predetermined duration Tcpk is not brought into play. This means that the predetermined duration Tcpk is not transmitted from the first node NA to the storage unit 006 in the tenth step 1009 described here below.

It may be noted that the order of the steps implemented by the first node NA, described with reference to FIG. 10, does not correspond perfectly to the order of the steps pertaining to this first node NA, described with reference to FIG. 5. Indeed, the order of certain steps is of little importance.

After the authentication phase DTCP has been implemented (step 1000), the first node NA obtains the content private key CPK (step 1001) transmitted by the storage management node NC. Then, the second mask m1 is computed (step 1002).

Then, a waiting step in which the first node NA waits for the generation of the first random number Nc is implemented (step 1003), and is followed by a step for verifying that the first random number Nc has been generated (step 1004). If the first random number Nc has not yet been generated, the waiting step 1003 is again implemented.

Once the first random number Nc has been generated by the first node NA, the first mask m1 is applied to the first random number Nc to compute the content private key number Ncpk (second key computation parameter) (step 1005).

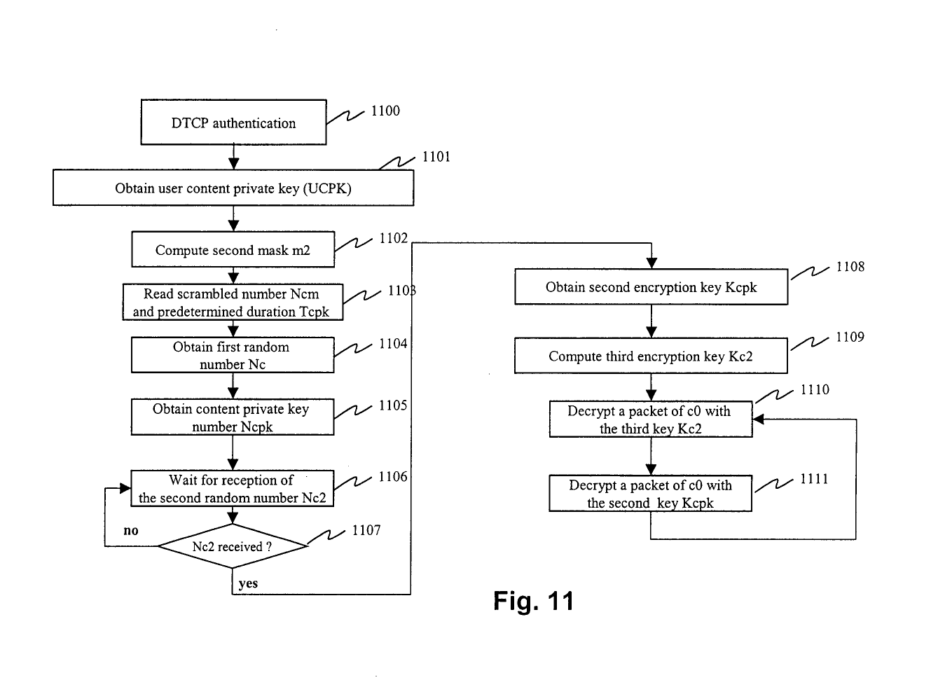

Then, the second encryption key Kcpk (step 1006) and the first encryption key Kc (step 1007) are computed by the first node NA. Then, the first random number Nc is scrambled by means of the first mask m1 in a step 1008 of computation of the scrambled number Ncm. The scrambled number Ncm is then sent to the storage unit 006 with the predetermined duration Tcpk (step 1009). These pieces of data are computation data that will serve during the performance of the read method described with reference to FIG. 11.

According to one variant, the predetermined duration Tcpk may also be scrambled by means of the first mask m1 during the step 1008, before it is transmitted to the storage unit in the step 1009.

Then, a first packet of the content c0 undergoes the first encryption with the second encryption key (step 1010) and a second encryption with the first encryption key (step 1011) by the first node NA. Thus, each of the packets of the content c0 undergoes a double encryption implemented by the first node NA before being transmitted to the storage unit.

Then, the first node NA transmits this first packet to the storage unit 006 (step 1012) before re-implementing the steps of double encryption 1010, 1011 and transmission 1012 successively for each of the other packets of the content c0 so that the entire encrypted content c0 is received by the storage unit 006.

A description has been given here above, with reference to FIG. 6, of the steps of the method for reading the content c0 according to the second and third embodiments of the invention. Referring now to FIG. 11, a description shall be given of the steps implemented by the first node NA when the storage method illustrated in FIG. 6 is executed.

Just as in the case of FIG. 6, only the third embodiment of the storage method shall be described here below, given that the second embodiment is identical to the third embodiment except that in the second embodiment, the predetermined duration is not brought into play. This means that the predetermined duration Tcpk is not read by the first node NA on the storage unit 006 in the fourth step 1103 described here below.

It may be noted that the order of the steps implemented by the first node NA, described with reference to FIG. 11, does not correspond perfectly to the order of the steps pertaining to this first node NA, described with reference to FIG. 6. Indeed, the order of certain steps is of little importance.

After the authentication phase DTCP has been implemented (step 1100), the first node NA obtains the content private key CPK (step 1101) transmitted by the storage management node NC. Then, the second mask m2 is computed (step 1102).

Then a step is implemented by the first node NA (step 1103) for the reading, on the storage unit 006, of the data for the computation, here, of the scrambled number Ncm as well as the predetermined duration Tcpk (previously transmitted by the storage unit).

Then, the first random number Nc (step 1104) as well as the content private key number Ncpk (step 1105) are obtained by the first node NA.

Then, a waiting step in which the first node NA waits for the reception of the second random number Nc2 (generated and then transmitted to the first node NA by the storage unit 006) is implemented (step 1106), and is followed by a step for verifying that the second random number Nc2 has been received by the first node NA (step 1107). If the second random number Nc2 has not yet been received, the waiting step 1107 is again implemented.

Once the second random number Nc2 has been received by the first node NA, the first node NA obtains the second encryption key Kcpk (step 1108) and computes the third encryption key Kc2 (step 1109).

Then a first content packet c0 is decrypted with the third encryption key Kc2 (step 1110) and decrypted with the second encryption key Kcpk (step 1111) by the first node NA.

Then the first node NA re-implements the decryption steps 1110, 1111 successively for each of the other packets of the content c0 so that the entire content c0 is totally decrypted (clear) and can be transmitted to the second node NB and then to the digital television set 009 to implement the read operation proper.

Referring now to FIG. 12, an algorithm is presented for the updating of the second encryption key, implemented by the first node NA during the implementation of the method for the storage of the content c0 according to the third embodiment of the invention.

After the selection of a first packet of the content c0 in a first step 1201 (in parallel with the double encryption of the above-mentioned steps 1010 and 1011 and the transmission of the above-mentioned step 1012), the first node NA resets a counter for updating the second encryption key Kcpk in a second step 1202.

Then, in a third step 1203, it increments the updating counter by means of a local clock of the first node NA, before verifying, in a fourth step 1204, that the updating counter has reached the predetermined duration Tcpk (re-updating parameter).

If the updating counter has not yet reached the duration Tcpk, then, in a fourth step, the node NA re-implements the above-mentioned third step 1203 while a succession of packets is transmitted to the storage unit 006.

If the updating counter has reached the duration Tcpk, then the node NA, in a fifth step 1205, waits for the current packet to be transmitted to the storage unit 006.

Once the current packet has been transmitted to the storage unit 006, the first node NA, in a sixth step 1206, implements the content private key number Ncpk. Then, by means of the incremented content private key number Ncpk, its computes a second updated encryption key, Kcpk, in a seventh step 1207.

The first node Na then re-implements the second step, so that the second encryption key is updated periodically.

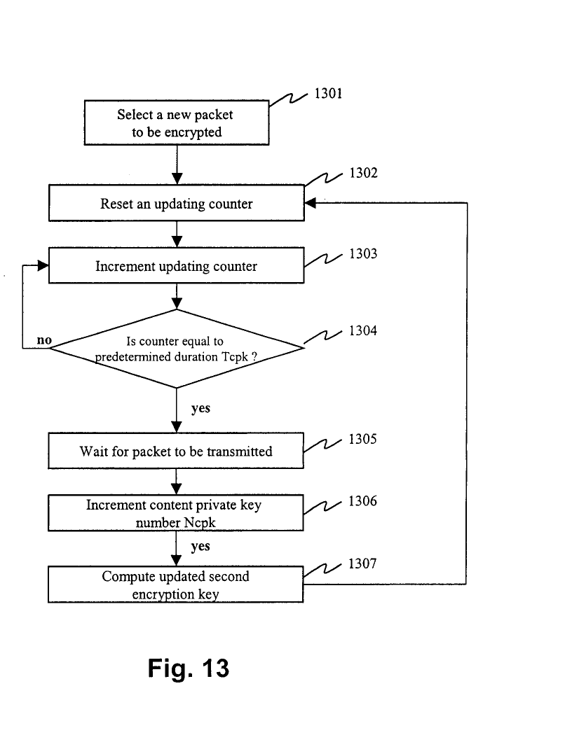

Referring now to FIG. 13, an algorithm is presented for the updating of the second encryption key, implemented by the first node NA during the implementation of the method for reading the content c0 according to the third embodiment of the invention.

After the selection of a first packet of the content c0 in a first step 1301 (in parallel with the above-mentioned decryption steps 1110 and 1111), the first node NA resets a counter for updating the second encryption key Kcpk in a second step 1302.

Then, in a third step 1303, it increments the updating counter by means of a local clock of the first node NA, before verifying, in a fourth step 1304, that the updating counter has reached the predetermined duration Tcpk (re-updating parameter).

If the updating counter has not yet reached the duration Tcpk, then, in a fourth step, the node NA re-implements the above-mentioned third step 1303 while a succession of packets is transmitted to the second node NB.

If the updating counter has reached the duration Tcpk, then the node NA, in a fifth step 1305, waits for the current packet to be transmitted to the second node NB.

Once the current packet has been transmitted to the second node NB, the first node NA, in a sixth step 1306, implements the content private key number Ncpk. Then, by means of the incremented content private key number Ncpki, its computes a second updated encryption key, Kcpki, in a seventh step 1307.

The first node Na then re-implements the second step, so that the second encryption key is updated periodically.

According to one variant of this third embodiment, the re-updating parameter may be a predetermined number of packets, this predetermined number being capable of encryption by means of the second encryption key Kcpk.

In this variant, the updating counter is incremented not through a local clock but rather in taking account of the packets of the content c0 transmitted.

With this third embodiment as well as its above-mentioned variant, the re-updating of the second encryption key Kcpk, provides an additional guarantee on control of access to the content.

Although the invention has been described here about with reference to a limited number of embodiments, those skilled in the art will understand, from the present description, that other embodiments can be conceived without departing from the framework of the present invention.

What is claimed is:

1. A method for the storage of a content from a source device to a storage device, the devices implementing a content protection protocol comprising a phase of exchanging a first encryption key associated with a first key computation parameter, the method comprising the steps of:
obtaining a first processing function that is a function of a predetermined piece of information for access to the content to be stored;
obtaining a second key computation parameter taking into account said first processing function;
computing a second encryption key taking into account said second key computation parameter;
encrypting the content to be stored with said second key, thus obtaining a first encrypted content;
encrypting the first encrypted content with the first encryption key, thus obtaining a second encrypted content;
sending the second encrypted content to the storage device; and
storing at least one piece of computation data necessary for the computation of said second key computation parameter.

2. A method according to claim 1, wherein the storage of said at least one piece of computation data is done by the sending the said at least one piece of data to the storage device.

3. A method according to claim 2, wherein said at least one piece of computation data is computed with a second function taking into account the first processing function obtained and the first key computation parameter.

4. A method according to claim 3, wherein said at least one piece of computation data is the first key computation parameter.

5. A method according to claim 3, wherein another piece of computation data is a parameter for re-updating the second key computation parameter.

6. A method according to claim 5, wherein the re-updating parameter is a time period of a predetermined duration.

7. A method according to claim 5 wherein, the content comprising packets, the re-updating parameter is a predetermined number of packets encrypted with the second key.

8. A method according to claim 5, further comprising the steps of:
implementating a mechanism making it possible to increment the second key computation parameter as a function of the re-updating parameter;
re-computating the second encryption key after each incrementation of the second key computation parameter.

9. A method according to claim 5, wherein the re-updating parameter for the second key computation parameter is encrypted by means of a third function taking account of the first processing function so as to form a piece of computation data.

10. A method according to claim 1, wherein the storage of said at least one piece of computation data is done locally.

11. A method according to claim 1, wherein said predetermined piece of information for access to the content to be stored is a password associated with said content and/or said storage device.

12. A method for the reading of a content coming from a storage device to a sink device, the content stored in the storage device having been encrypted by a second encryption key as a first encrypted content, said devices implementing a content protection protocol comprising a phase of exchange of a third encryption key associated with a third key computation parameter, the method comprising the steps of:
receiving a third encrypted content from the storage device, obtained by encryption with the third encryption key of the first encrypted content;
obtaining at least one piece of computation data;
obtaining a second processing function which is a function of a piece of information authorizing access to the content to be read;
obtaining a fourth key computation parameter taking into account said second processing function and said computation data;
computing a fourth encryption key taking into account said fourth key computation parameter;
decrypting the third encrypted content with the third encryption key, thus obtaining said first encrypted content; and
decrypting said first encrypted content with the fourth encryption key, thus obtaining a decrypted content.

13. A method according to claim 12, wherein the second encryption key has been computed by using a second key computation parameter, which has been obtained by using a first processing function, said second processing function is identical to said first processing function, if the access authorizing information corresponds to a predetermined piece of information used for obtaining said first processing function for access to the stored content.

14. A method according to claim 12, wherein the non-encrypted content is obtained in the decrypting step for said first encrypted content if the access authorizing information corresponds to a predetermined piece of information used for obtaining said first processing function for access to the stored content.

15. A method according to claim 12, wherein the fourth key computation parameter is computed, with a first function, in taking account of the second processing function and a first key computation parameter obtained by the computation according to a second function taking account of said at least one piece of computation data and the second processing function.

16. A method according to claim 12, wherein the obtaining of said at least one piece of computation data is done by the reading of this piece of data stored in the storage device.

17. A method according to claim 12, wherein one of said at least one piece of computation data is a parameter for re-updating the second key computation parameter.

18. A method according to claim 17, wherein the re-updating parameter is a time period of a predetermined duration.

19. A method according to claim 17 wherein, the content comprising packets, the re-updating parameter is a predetermined number of packets encrypted with the second encryption key.

20. A method according to claim 17, further comprising the steps of:
implementing a mechanism enabling the incrementing of the fourth key computation parameter as a function of the re-updating parameter;
re-computing the second encryption key after each incrementation of the fourth key computation parameter.

21. A method according to claim 12, wherein the obtaining of said at least one computation data is done by the retrieval of said at least one computation data from a source device.

22. A method according to claim 12, wherein said access authorization information is a user password.

23. A method according to claim 12, wherein said access authorization information is a password associated with said content and/or said storage device.

24. A computer program product comprising program code instructions such that when executed on a computer it performs the steps of the storage method according to claim 1.

25. A computer program product comprising program code instructions such that when executed on a computer it performs the steps of the content reading method according to claim 12.

26. A source device implementing means for storage of a content on a storage device, the devices implementing a content protection protocol comprising a phase for the exchange of a first encryption key associated with a first key computation parameter, the storage device comprising:
means for obtaining a first processing function which is a function of a predetermined piece of information for access to the content to be stored;
means for obtaining a second key computation parameter taking into account said first processing function;
means for computing a second encryption key taking into account said second key computation parameter;
first encryption means for encrypting the content to be stored with said second key, thus making it possible to obtain a first encrypted content,
second encryption means for encrypting the first encrypted content with the first encryption key, thus making it possible to obtain a second encrypted content; and
means for sending the second encrypted content to the storage device, the second encrypted content being stored with at least one computation data element necessary for the content of said second parameter.

27. A sink device for receiving a content coming from a storage device, the content stored in the storage device having been encrypted by a second encryption key as a first encrypted content, said sink device and said storage device implementing a content protection protocol comprising a phase of exchange of a third encryption key associated with a third key computation parameter, the sink device comprising:
means for receiving a third encrypted content of the storage device, the third encrypted content having been obtained by encrypting the first encrypted content with the third encryption key;
means for obtaining at least one computation data element;
means for obtaining a second processing function that is a function of a piece of information for authorization of access to the content to be read;
means for obtaining a fourth key computation parameter, taking account of said second processing function and said computation data element;
means for computing a fourth encryption key, taking account of said fourth key computation parameter;
means for decrypting said third encrypted content with the third encryption key so as to obtain said first encrypted content, and
means for decrypting said first encrypted content with the fourth encryption key so as to obtain a decrypted content.

28. A sink device according to claim 27, wherein the second encryption key has been computed by using a second key computation parameter, which has been obtained by using a first processing function, said second processing function is identical to said first processing function, if the access authorizing information corresponds to a predetermined piece of information used for obtaining said first processing function for access to the stored content.

29. A sink device according to claim 27, wherein the non-encrypted content is obtained in the decrypting step for said first encrypted content if the access authorizing information corresponds to a predetermined piece of information used for obtaining said first processing function for access to the stored content.
